(19) United States
(12) Patent Application Publication
(10) Pub. No.: US 2007/0028474 A1
(43) Pub. Date: Feb. 8, 2007

(54) Cutting square

(76) Inventor: Roger A. Dickey, Springerville, AZ (US)

Correspondence Address: DONALD R. SCHOONOVER, 4211 ROLLING HILLS DRIVE, NIXA, MO, 65714-8771, US

(21) Appl. No.: 11/196,066

(22) Filed: Aug. 4, 2005

(51) Int. Cl. B43L 13/00

(52) U.S. Cl. 33/427

(57) ABSTRACT

An instrument which is used to guide placement of a cutting line on a workpiece includes a multiplicity of notches on one edge thereof. The notches are spaced apart by preset distances and are sized to securely hold a pencil, or other such marking instrument, in place while the guide is moved along the workpiece in order to place a true line on the workpiece.

### BACKGROUND OF THE INVENTION

1. Field of the Invention

The present invention relates to the general art of geometric instruments, and to the particular field of devices used to mark a workpiece for cutting.

2. Description of the Related Art

In the field of carpentry accessories, there are complex and unwieldy devices intended to help in one way or another to establish right angles and miter cuts, spaced parallel cuts, and so forth. Some of these are designed to replace existing, simpler structures, and others add additional tools that must be carried on-site by the carpenter. A tool must be simple, lightweight and compact to be accepted by the trade since a tradesman can already do anything he needs to do with the tools he already has. Tools that replace an existing tool and eliminate one or more small inconveniences from the job without adding pounds or cubic inches to the tool mass, have a chance of success.

An annoyance arises when a worker needs to cut off an orthogonal length of a plank. Traditionally this is done by laying a planar carpenter's square on the plank with one leg along the length of the board and the other leg laying across the board, and making a transverse pencil line across the whole run of the cut-off path. Then a saw, usually a hand-held circular saw used extensively by framing carpenters and the like, is used to follow the line across the board.

While placing a line on a plank to be cut may sound easy, this is often an onerous task because the pencil may not follow a true line. To overcome this problem, some workers make several short lines and then connect the short lines. This can be a time consuming and annoying task.

Therefore, there is a need for a device for efficiently placing a true line on a plank to be cut.

### PRINCIPAL OBJECTS OF THE INVENTION

It is a main object of the present invention to provide a device for efficiently placing a true line on a plank to be cut.

It is another object of the present invention to provide a device for efficiently placing a true line on a plank to be cut and which is easy to use.

### SUMMARY OF THE INVENTION

These, and other, objects are achieved by a cutting square that has a multiplicity of notches defined on one edge thereof. The notches are spaced apart at preset intervals and are sized to securely support a carpenter's pencil in place while the square is moved across a plank to be marked for cutting.

Using an embodiment of the present invention will permit a worker to efficiently and easily place a true mark on a workpiece to be cut. The notches securely hold a writing instrument in place during the marking process.

### BRIEF DESCRIPTION OF THE DRAWING FIGURES

FIG. 1 is a perspective view of a cutting square embodying the present invention.

FIG. 2 is a plan view of the cutting square shown in FIG. 1.

FIG. 3 is a perspective view of a portion of an edge of the cutting square shown in FIG. 1.

FIG. 4 shows a pencil being held in place on a workpiece by the cutting square embodying the present invention.

### DETAILED DESCRIPTION OF THE PREFERRED EMBODIMENT

Other objects, features and advantages of the present invention will become apparent from a consideration of the following detailed description and the accompanying drawings.

Referring to the Figures, it can be understood that the present invention is embodied in a cutting square 10 that achieves the above-stated objectives.

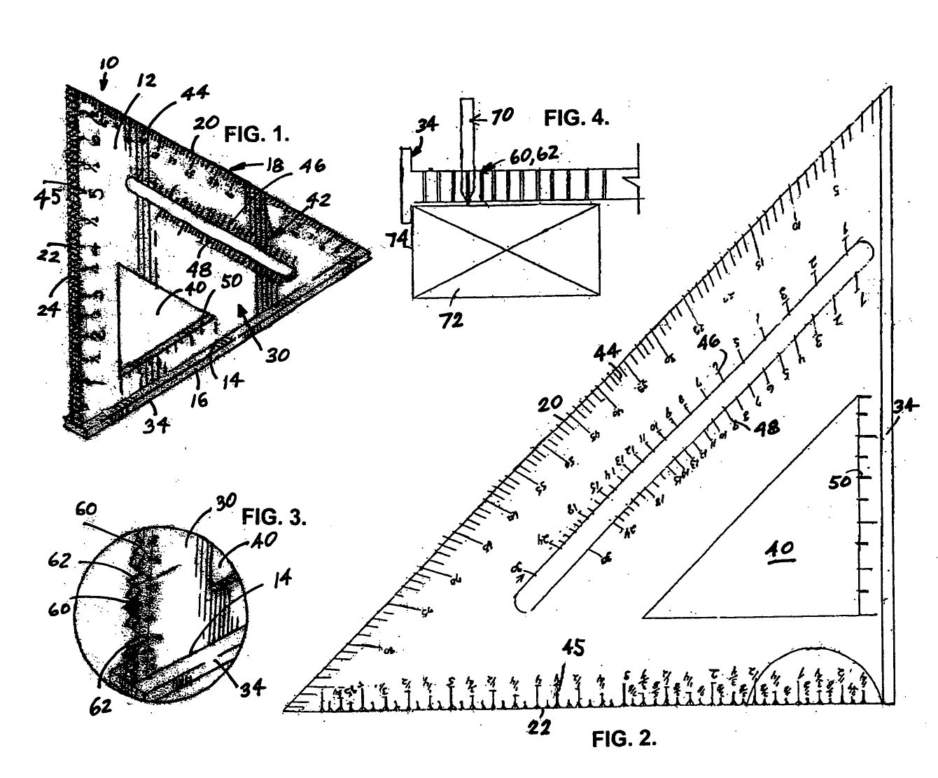

Cutting square 10 comprises a frame 12 that is in the shape of a triangle and which includes a first leg 14 having an edge 16 that is an outer edge, a second leg 18 having an edge 20 that is an outer edge and a third leg 22 having an edge 24 that is an outer edge. Frame 12 further includes a planar body 30 which can be formed of metal, such as aluminum or the like. In the form shown in FIG. 1, frame 30 is in the form of a right triangle with second leg 18 forming a hypotenuse of the right triangle.

A base element 34 is located on outer edge 16 of first leg 18. Base element 34 is oriented in a plane that is perpendicular to the plane containing planar body 30.

Frame 12 further includes a triangular cutout 40 defined in planar body 30 and an elongated rectangular cutout 42 also defined in planar body 30.

A multiplicity of first measuring marks 44 are located on planar body 30 adjacent to outer edge 20 of second leg 18, a multiplicity of second measuring marks 45 on planar body 30 adjacent to outer edge 24 of third leg 22.

A multiplicity of third measuring marks 46 are positioned on planar body 30 adjacent to one edge of rectangular cutout 42 and a multiplicity of fourth measuring marks 48 are located on the planar body adjacent to a second edge of rectangular cutout 42.

A multiplicity of fifth measuring marks 50 are located on planar body 30 adjacent to one edge of triangular cutout 40.

The above-mentioned marks can measure distance, angles, or the like.

A multiplicity of notches, such as notches 60 and 62, are defined in outer edge 24 of third leg 22 of frame 12. The notches extend in a plane that is perpendicular to the plane containing planar body 30 and are spaced apart from each other by preset spacings in the direction of the outer edge 24 of the third leg 22 between the first leg 14 and the second leg 18. Each notch is sized and adapted to securely accommodate a marking instrument, such as a carpenter's pencil 70 shown in FIG. 4 for marking a workpiece, such as a board 72 to be cut. In the embodiment shown in FIG. 1, the notches 60 and 62 are spaced apart from each other by a distance of ⅛ inch, and every fourth notch 62 extending farther into the planar body from outer edge 24 of third leg 22 and being wider than the notches 60 adjacent thereto.

Operation of cutting square 10 can be understood from the teaching of the foregoing description and thus will be only briefly discussed. As indicated in FIG. 4, square 10 is positioned adjacent to an end 74 of a workpiece 72 with base element 34 firmly engaging end 74. A marking instrument, such as pencil 70, is located adjacent to a selected notch and is oriented to mark workpiece 74. Cutting square 10 is then moved (in the instances shown in FIG. 4, such movement will be into and out of the plane of the paper) with the marking instrument engaging the workpiece to define a cutting guide line on the workpiece. The notches keep the marking instrument firmly in place during the marking process.

It is understood that while certain forms of the present invention have been illustrated and described herein, it is not to be limited to the specific forms or arrangements of parts described and shown.

What is claimed and desired to be covered by Leters Patent is:

1. A cutting square comprising:
(a) a frame that is in the shape of a triangle and which includes
(1) a first leg having an edge that is an outer edge,
(2) a second leg having an edge that is an outer edge,
(3) a third leg having an edge that is an outer edge,
(4) a planar body,
(5) a base element on the outer edge of the first leg, the base element being oriented in a plane that is perpendicular to the plane containing the planar body,
(6) a triangular cutout defined in the planar body,
(7) an elongated rectangular cutout defined in the planar body,
(8) a multiplicity of first measuring marks on the planar body adjacent to the outer edge of the second leg,
(9) a multiplicity of second measuring marks on the planar body adjacent to the outer edge of the third leg,
(10) a multiplicity of third measuring marks on the planar body adjacent to one edge of the rectangular cutout,
(11) a multiplicity of fourth measuring marks on the planar body adjacent to a second edge of the rectangular cutout, and
(12) a multiplicity of fifth measuring marks on the planar body adjacent to one edge of the triangular cutout; and
(b) a multiplicity of notches defined in the outer edge of the third leg of said frame, the notches extending in a plane that is perpendicular to the plane containing the body of said frame and being spaced apart from each other by preset spacings in the direction of the outer edge of the third leg between the first leg and the second leg, each notch being sized and adapted to securely accommodate a marking instrument.

2. The cutting square as described in claim 1 wherein the marking instrument is a carpenter's pencil.

3. The cutting square as described in claim 1 wherein the planar body is formed of metal.

4. The cutting square as described in claim 1 wherein the notches are spaced apart from each other by a distance of ⅛ inch.

5. The cutting square as described in claim 4 wherein every fourth notch extends farther into the planar body from the outer edge of the third leg of said frame and is wider than the notches adjacent thereto.

6. The cutting square as described in claim 1 wherein said frame forms a right triangle, and the second leg forms a hypotenuse of the right triangle.
